(19) United States
(12) Patent Application Publication
(10) Pub. No.: US 2006/0144938 A1
(43) Pub. Date: Jul. 6, 2006

(54) Wine data scanner, related database system and method of using same

(76) Inventor: Donna David, Long Beach, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/029,284

(22) Filed: Jan. 5, 2005

(51) Int. Cl. G06Q 30/00

(52) U.S. Cl. 235/385

(57) ABSTRACT

A wine data scanner is used to read the bottler's optically-coded information on each wine bottle along with an optically-coded, unique identifier affixed by the wine owner. The scanned information is input to a computerized database, typically via removable magnetic media encoded in the scanner, where additional information such as date of acquisition, recommended consumption schedule, reviews, care and maintenance data and location data is added. The scanner will provide auditory and visual confirmation of data scanned. The database can be used to control inventory levels and wine rotation, to research additional data related to the wine and to locate a particular bottle when location information is linked to the unique identifier affixed to the bottle.

### FIELD OF INVENTION

The invention pertains to a method for managing and tracking wine bottles in a wine collection. More particularly, the invention relates to a scanning system used to input wine bottle information into a relational database and uses of that database control the wine collection inventory.

### BACKGROUND OF THE INVENTION

Avid wine collectors often own hundreds or even thousands of bottles of wine. The organization, storage, maintenance and location of these wine bottles presents a major problem for the collector as the size of his collection increases. Computer technology provides a number of ways in which these tasks may be simplified and the collection better managed. Most wine bottled today includes a label printed with a bar code. This code provides various information related to the wine, typically including the bottler's name, the wine variety, bottling date and other information useful to the wholesaler or retailer. This information is also useful to the wine collector when augmented with other information added by the collector along with means of searching and displaying this information. Various systems have been developed for providing coded, printable information, reading the codes, and managing inventories of various types.

U.S. Pat. No. 6,450,406 describes a portable, integrated scanner/scale apparatus capable of scanning and weighing articles of inventory and particularly intended for use with a method of inventorying bottled liquids, specifically liquor at a bar, or pharmaceuticals. The integrated scanner/scale apparatus is defined by a housing containing a scanner, a weighing scale, and a plurality of other components used by the scanner/scale apparatus for gathering, recording, and distributing inventory data.

Housed inside the integrated scanner/scale apparatus is a memory device for storing information obtained from the scanner/scale apparatus, a display device for displaying data either generated by the scanner or scale or entered by the key pad, and a serial port or RF communications devices for enabling interconnection between the memory device and a personal computer having a software program for calculating inventory stock amounts and profits, etc.

U.S. Pat. No. 6,325,291 discloses an element which can be plugged into an electronic data processing (EDP) device, for receiving a user card which is equipped with components, including at least one of a processor and/or data memory, a frame having an exterior form, which is designed to accommodate the user card, a first interface for transferring data between the element and the EDP device, and a second interface formed by contacts on the user card and on the frame, for transferring data to and from the user card. The exterior form of the frame is that of a diskette so that it can be inserted into a diskette station of an EDP device.

The first interface between the element and the EDP device is designed in a standard fashion, so that data can be transferred using a standard read/write device already present in the diskette station of the EDP device. The frame carries a battery for supplying current via the interface to the components located on the user card, if required, and carries an additional processor and data memory for providing the element with additional processor and storage capacity.

U.S. Pat. Nos. 6,158,660 and 6,722,568 are directed to systems for improved detection and decoding of a supplemental bar code label accompanying a primary bar code label is described. A supplemental label is affixed to a product in the vicinity of a primary label. A scanner in a bar code reading system, such as a point of sale system, scans for a primary label. Upon detection of a primary label, the system looks for the bar code encoded on the label in a database containing a set of bar codes with a value associated with each bar code. The value determines how long a search is to be conducted for a supplemental label accompanying the primary label which was scanned. The duration may suitably be based on the probability that a supplemental label will be present. It may also be influenced by the difficulty of detecting a supplemental label which may be present. The database may be preprogrammed, or may be built as scanning proceeds and experience is gained about which primary labels are accompanied by supplemental labels and the time typically required to detect such labels.

U.S. Pat. No. 5,986,219 discloses a liquor inventorying method for determining the amount of liquor dispensed during a shift in a restaurant or bar and therefore discouraging theft or overpouring of the liquor is disclosed. The method is implemented with the aid of a weigh scale and a computer program and includes the steps of separating all of the liquor bottles in the bar or restaurant into a plurality of categories based on similar characteristics between the liquor bottles such as liquor costs; determining an approximate average cost of liquor per unit weight in each category; weighing all of the bottles in a category in groups after a shift to determine how much liquor was dispensed from the category; determining the approximate cost of liquor dispensed from all of the liquor bottles within the category, and comparing the approximate total cost of liquor dispensed from the category to the amount of revenue received.

U.S. Patent Application No. 2004/0181464 is directed to a method for transferring information between multiple buyers and multiple vendors is provided. Information is received from a plurality of sources. This information corresponds to a plurality of products. This information is stored in a first database. A request is received. The request concerns a portion of the information stored in the first database. The request is then retrieved from the first database and posted to a second database. Access is provided to subsets of the second database to a plurality of subscribers.

It is an objective of the present invention to provide a system for the wine collector to utilize the encoded information provided on wine bottles by the bottler. It is a further objective to provide means for the collector to add unique identifiers to the wine bottle for future identification. It is a further objective of the invention to provide a system that permits the encoded information to be scanned into a database for organization and future searching. Finally, it is an objective of the invention to provide a capability for the collector to add additional information to the database relating to each wine bottle for future reference.

While some of the objectives of the present invention are disclosed in the prior art, none of the inventions found include all of the requirements identified.

### SUMMARY OF THE INVENTION

The present invention addresses all of the deficiencies of prior art wine scanning and related database inventions and satisfies all of the objectives described above.

(1) A wine scanning and related database system providing the desired features may be constructed from the following components. At least one wine bottle is provided. The wine bottle has machine readable encoded information located on it. A plurality of attachable indicia are provided. Each of the indicia includes unique identifying information in the machine readable encoded format. A scanner for scanning coded articles is provided. The scanner includes a memory device. A computerized data base is provided. The database receives information stored in the memory device and information input through at least one additional input device. A display device is provided. The display device is linked to the computerized data base. A database search program is provided. The search program is capable of locating and displaying information in the database based upon input search criteria. When the wine bottle is scanned with the scanner, information related to the bottle, including at least a unique identifier, will be stored in the memory device. The information is subsequently transmitted to the computerized database. When information is input through the additional input device, it will be linked to the unique identifier. All of the information is searched and displayed through the database search program.

(2) In a variant of the invention, the encoded information located upon the wine bottle is a bar code including information related to wine stored in the bottle.

(3) In a further variant, the attachable indicia is a label including a bar code for the unique identifier.

(4) In still a further variant, the scanner includes a display device.

(5) In yet another variant, the scanner includes a signal device indicating a successful scan.

(6) In another variant of the invention, the memory device of the scanner includes removable memory media and a writer for the removable memory media.

(7) In a further variant, the computerized database receives input from at least one device selected from removable memory media, wireless transmission, keyboard and wired transmission.

(8) In still a further variant, the computerized database includes data fields such as the unique identifier, wine manufacturer, wine type, date of production, date of purchase, intended consumption date range, storage location, care requirements, reviews and comments.

(9) In yet another variant, the computerized database is searchable by any combination of the fields.

(10) In still another variant, the computerized database includes a reporting feature. The reporting feature provides reports related to the input data fields and statistics related to the fields.

(11) A method of using a wine scanner system and related database, includes the steps of: Providing at least one wine bottle. The wine bottle has machine readable encoded information located on it by the bottler. Providing a plurality of attachable indicia. Each of the indicia includes unique identifying information in the machine readable encoded format. Providing a scanner for scanning coded articles. The scanner includes a memory device. Providing a computerized database. The database receives information stored in the memory device and information input through at least one additional input device. Providing a display device. The display device is linked to the computerized database. Providing a database search program. The search program is capable of locating and displaying information in the database based upon input search criteria. Attaching one of each of the indicia to each wine bottle. Scanning the attachable indicia on one of the wine bottles. Scanning the machine readable encoded information located upon the wine bottle by the bottler. Linking the unique identifying information to the information located upon the wine bottle by the bottler. Recording the scanned information on the memory device. Transmitting the recorded information to the computerized database. Inputting additional information related to the wine bottle. Linking the additional information to the unique identifying information. Searching the database based upon any of the input information.

(12) A method of using a wine scanner system and related database, including the steps of: Providing at least one wine bottle. The wine bottle has machine readable encoded information located on it by the bottler. Providing a plurality of attachable indicia. Each of the indicia includes unique identifying information in the machine readable encoded format. Providing a scanner for scanning coded articles. The scanner includes a memory device. Providing a computerized database. The database receives information stored in the memory device and information input through at least one additional input device. Providing a display device. The display device is linked to the computerized database. Providing a database search program. The search program is capable of locating and displaying information in the database based upon input search criteria. Scanning the machine readable encoded information located upon the wine bottle by the bottler. Recording the scanned information on the memory device. Transmitting the recorded information to the computerized database. Inputting additional information related to the wine bottle. Duplicating the recorded information and the additional information for a plurality of identical bottles. Entering unique identifiers for each of the bottles. Attaching one of each of the indicia to each wine bottle. The indicia correspond to the entered unique identifiers. Entering location information for each of the bottles in the database. Searching the database based upon any of the input information.

(13, 14) In a variant of the invention, the method of using a wine scanner system and related database, includes the further steps of: Scanning a bottle which has previously been scanned and which has information stored in the database and retrieving information relating to the bottle.

(15, 16) In a final variant of the invention, the method of using a wine scanner system and related database, includes the further steps of: Searching the computerized database based upon a search criteria. Retrieving the unique identifier and location information for at least one selected bottle. Retrieving the bottle from an identified storage location.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of a wine bottle illustrating the bottler's bar code and a bar code attached by the wine collector;

FIG. 2 is a a perspective view of a roll of serialized bar code labels for use with the FIG. 1 embodiment;

FIG. 3 is a side elevational view of a scanner for use with the FIG. 1 embodiment illustrating a viewing screen;

FIG. 4 is a front elevational view of a computer system and wine inventory database;

FIG. 5 is front elevational view of a wine storage rack illustrating an identifying numbering system;

FIG. 6 is a schematic view illustrating the information encoded in a bottler's bar code label;

FIG. 7 is a schematic view illustrating the information encoded in a collector's bar code label; and

FIG. 8 is a schematic layout of the wine inventory database field layouts.

### DETAILED DESCRIPTION OF THE PREFERRED EMBODIMENT

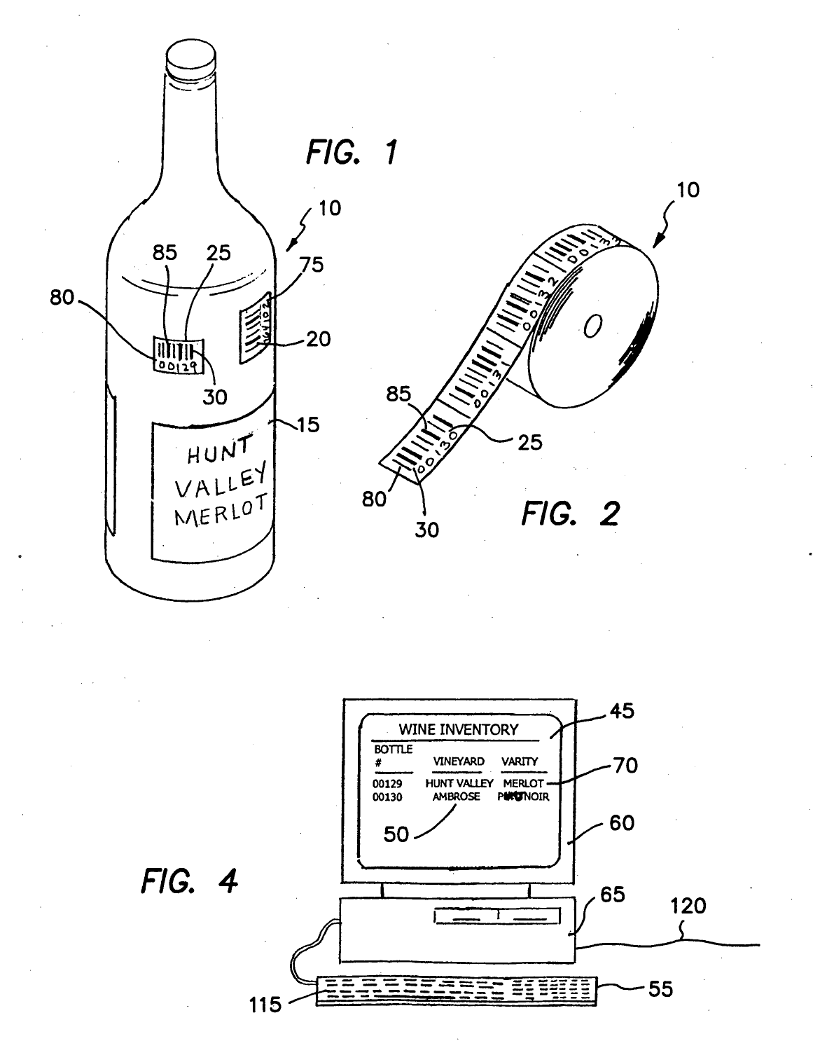

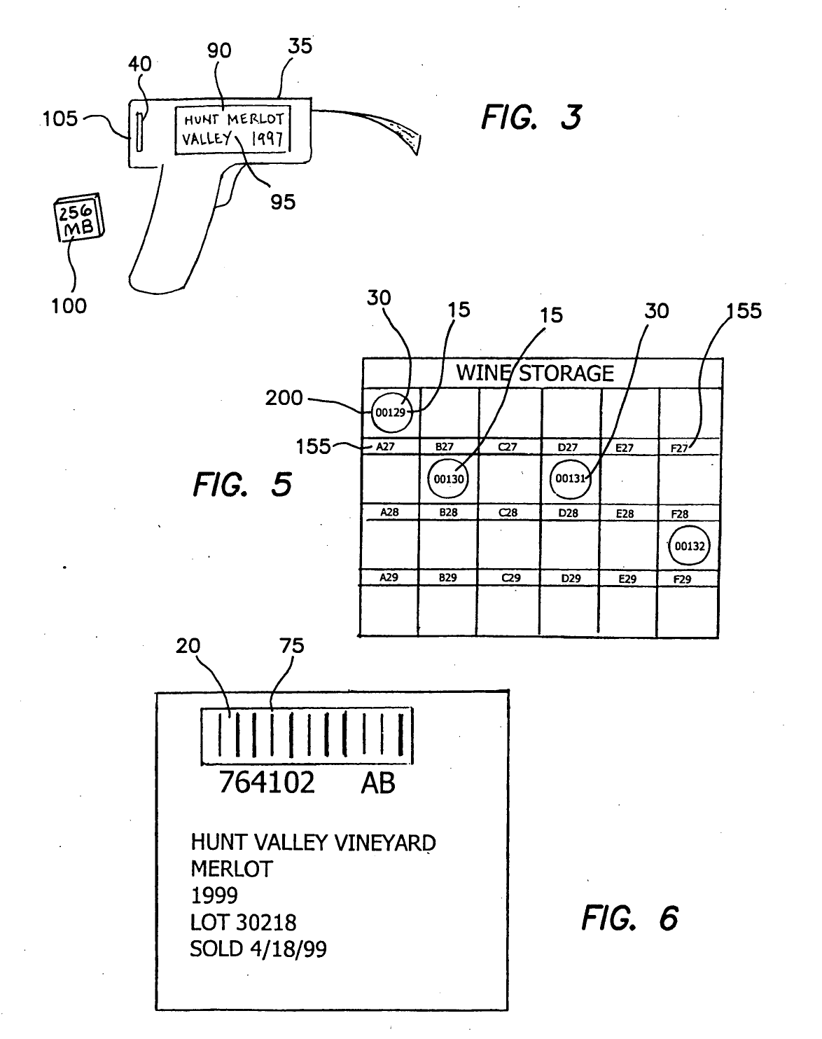

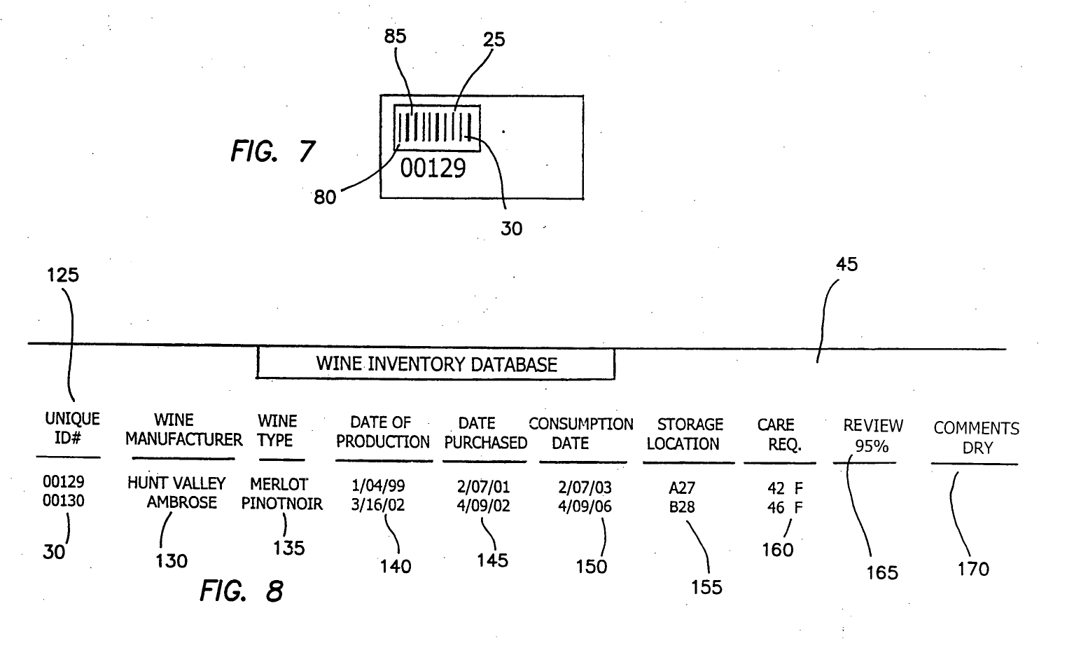

(1) FIGS. 1-8 illustrate a wine scanning and related database system 10 providing the desired features that may be constructed from the following components. At least one wine bottle 15, as illustrated in FIG. 1, is provided. The wine bottle 15 has machine readable encoded information 20, as illustrated in FIGS. 1 and 6, located on it. A plurality of attachable indicia 25 are provided. Each of the indicia 25, as illustrated in FIGS. 1 and 2, includes unique identifying information 30 in the machine readable encoded format. A scanner 35, as illustrated in FIG. 3, for scanning coded articles is provided. The scanner 35 includes a memory device 40. A computerized data base 45 is provided. The database 45, as illustrated in FIG. 4, receives information stored in the memory device 40 and information 50 input through at least one additional input device 55. A display device 60 is provided. The display device 60 is linked to the computerized data base 45. A database search program 65 is provided. The search program 65 is capable of locating and displaying information in the database 45 based upon input search criteria 70. When the wine bottle 15 is scanned with the scanner 35, information 20 related to the bottle 15, including at least a unique identifier 30, will be stored in the memory device 40. The information 20, 30 is subsequently transmitted to the computerized database 45. When information 50 is input through the additional input device 55, it will be linked to the unique identifier 30. All of the information is searched and displayed through the database search program 65.

(2) In a variant, as illustrated in FIG. 1, of the invention, the encoded information 20 located upon the wine bottle 15 is a bar code 75 including information 20 related to wine stored in the bottle 15.

(3) In a further variant, the attachable indicia 25 is a label 80 including a bar code 85 for the unique identifier 30.

(4) In still a further variant, as illustrated in FIG. 3, the scanner 35 includes a display device 90.

(5) In yet another variant, the scanner 35 includes a signal device (not shown) indicating a successful scan 95.

(6) In another variant of the invention, the memory device 40 of the scanner 35 includes removable memory media 100 and a writer 105 for the removable memory media 100.

(7) In a further variant, as illustrated in FIG. 4, the computerized database 45 receives input from at least one device 55 selected from removable memory media 100, wireless transmission (not shown), keyboard 115 and wired transmission 120.

(8) In still a further variant, the computerized database 45 includes data fields 125 such as the unique identifier 30, wine manufacturer 130, wine type 135, date of production 140, date of purchase 145, intended consumption date range 150, storage location 155, care requirements 160, reviews 165 and comments 170.

(9) In yet another variant, the computerized database 45 is searchable by any combination of the fields 125.

(10) In still another variant, the computerized database 45 includes a reporting feature 175. The reporting feature 175 provides reports 180 related to the input data fields 125 and statistics 185 related to the fields 125.

(11) A method of using a wine scanner system and related database 10, includes the steps of: Providing at least one wine bottle 15. The wine bottle 15 has machine readable encoded information 20 located on it by the bottler. Providing a plurality of attachable indicia 25. Each of the indicia 25 includes unique identifying information 30 in the machine readable encoded format. Providing a scanner 35 for scanning coded articles. The scanner 35 includes a memory device 40. Providing a computerized database 45. The database 45 receives information 20, 30 stored in the memory device 40 and information 50 input through at least one additional input device 55. Providing a display device 85. The display device 85 is linked to the computerized database 45. Providing a database search program 65. The search program 65 is capable of locating and displaying information 20, 30, 50 in the database 45 based upon input search criteria 70. Attaching one of each of the indicia 25 to each wine bottle 15. Scanning the attachable indicia 25 on one of the wine bottles 15. Scanning the machine readable encoded information 20 located upon the wine bottle 15 by the bottler. Linking the unique identifying information 30 to the information 20 located upon the wine bottle 15 by the bottler. Recording the scanned information 20, 30 on the memory device 40. Transmitting the recorded information 20, 30 to the computerized database 45. Inputting additional information 50 related to the wine bottle 15. Linking the additional information 50 to the unique identifying information 30. Searching the database 45 based upon any of the input information 20, 30, 50.

(12) A method of using a wine scanner system and related database 10, including the steps of: Providing at least one wine bottle 15. The wine bottle 15 has machine readable encoded information 20 located on it by the bottler. Providing a plurality of attachable indicia 25. Each of the indicia 25 includes unique identifying information 30 in the machine readable encoded format. Providing a scanner 35 for scanning coded articles. The scanner 35 includes a memory device 40. Providing a computerized database 45. The database 45 receives information 20, 30 stored in the memory device 40 and information 50 input through at least one additional input device 55. Providing a display device 85. The display device 85 is linked to the computerized database 45. Providing a database search program 65. The search program 65 is capable of locating and displaying information 20, 30, 50 in the database 45 based upon input search criteria 70. Scanning the machine readable encoded information 20 located upon the wine bottle 15 by the bottler. Recording the scanned information 20 on the memory device 40. Transmitting the recorded information 20 to the computerized database 45. Inputting additional information 50 related to the wine bottle 15. Duplicating the recorded information 20 and the additional information 50 for a plurality of identical bottles 15. Entering unique identifiers 30 for each of the bottles 15. Attaching one of each of the indicia 25 to each wine bottle 15. The indicia 25 correspond to the entered unique identifiers 30. Entering location information 195 for each of the bottles 15 in the database 45. Searching the database 45 based upon any of the input information 20, 30, 50.

(13, 14) In a variant of the invention, the method of using a wine scanner system and related database 10, includes the further steps of: Scanning a bottle 15 which has previously been scanned and which has information 20, 30, 50 stored in the database 45 and retrieving information 20, 30, 50 relating to the bottle 15.

(14, 15) In a final variant, as illustrated in FIG. 5, of the invention, the method of using a wine scanner system and related database 10, includes the further steps of: Searching the computerized database 45 based upon a search criteria 70. Retrieving the unique identifier 30 and location information 195 for at least one selected bottle 15. Retrieving the bottle 15 from an identified storage location 200.

The wine scanner system and related database 10 has been described with reference to particular embodiments. Other modifications and enhancements can be made without departing from the spirit and scope of the claims that follow.

1. A wine collection scanner system, not for use with liquor at a bar, and related database comprising:
at least one wine bottle, said wine bottle having machine readable encoded information disposed thereon;
a plurality of attachable indicia, each of said indicia comprising unique identifying information in said machine readable encoded information format;
a scanner for scanning coded articles, said scanner comprising a memory device;
a computerized database, said database receiving information stored in said memory device and information input through at least one additional input device;
a display device, said display device being linked to said computerized database;
a database search program, said search program capable of locating and displaying information in said database based upon input search criteria; and
whereby, when said wine bottle is scanned with said scanner, information related to said bottle, comprising at least a unique identifier, will be stored in said memory device, said information subsequently being input through said additional input device, said information will be linked to said unique identifier, all of said information being searched and displayed through said database search program wherein the system is not for use with liquor at a bar.

2. The wine scanner system and related database, as described in claim 1, wherein said machine readable encoded information disposed upon said wine bottle is a bar code comprising information related to wine stored in said bottle.

3. The wine scanner system and related database, as described in claim 1, wherein said attachable indicia is a label comprising a bar code for said unique identifier.

4. The wine scanner system and related database, as described in claim 1, wherein said scanner further comprises a display device.

5. The wine scanner system and related database, as described in claim 1, wherein said scanner further comprises a signal device indicating a successful scan.

6. The wine scanner system and related database, as described in claim 1, wherein said memory device of said scanner further comprises removable memory media and a writer for said removable memory media.

7. The wine scanner system and related database, as described in claim 1, wherein said computerized database receives input from at least one device selected from:
removable memory media, wireless transmission, keyboard and wired transmission.

8. The wine scanner system and related database, as described in claim 1 wherein said computerized database includes data fields comprising said unique identifier, wine manufacturer, wine type, date of production, date of purchase, intended consumption date range, storage location, care requirements, reviews and comments.

9. The wine scanner system and related database, as described in claim 8 wherein said computerized database is searchable by any combination of said fields.

10. The wine scanner system and related database, as described in claim 9 wherein said computerized database further comprises a reporting feature, said reporting feature providing reports related to said input data fields and statistics related to said fields.

11. A method of using a wine collection scanner system, not for use with liquor at a bar, and related database, comprising the steps of:
providing at least one wine bottle, said wine bottle having machine readable encoded information disposed thereon by the bottler;
providing a plurality of attachable indicia, each of said indicia comprising unique identifying information in said machine readable encoded format;
providing a scanner for scanning coded articles, said scanner comprising a memory device;
providing a computerized database, said database receiving information stored in said memory device and information input through at least one additional input device;
providing a display device, said display device being linked to said computerized database;
providing a database search program, said search program capable of locating and displaying review information in said database based upon input search criteria;
attaching one of each said indicia to each wine bottle;
scanning said attachable indicia on one of said wine bottles;
scanning said machine readable encoded information disposed upon said wine bottle by the bottler;
linking said unique identifying information to said information disposed upon said wine bottle by the bottler;
recording said scanned information on said memory device;
transmitting said recorded information to said computerized database;
inputting additional information related to said wine bottle;
linking said additional information to said unique identifying information; and
searching said database based upon any of the input information wherein the system is not for use with liquor at a bar.

12. A method of using a wine scanner system and related database, comprising the steps of:
providing at least one wine bottle, said wine bottle having machine readable encoded information disposed thereon by the bottler;
providing a plurality of attachable indicia, each of said indicia comprising unique identifying information in said machine readable encoded format;
providing a scanner for scanning coded articles, said scanner comprising a memory device;
providing a computerized database, said database receiving information stored in said memory device and information input through at least one additional input device;
providing a display device, said display device being linked to said computerized database;
providing a database search program, said search program capable of locating and displaying information in said database based upon input search criteria;
scanning said machine readable encoded information disposed upon said wine bottle by the bottler;
recording said scanned information on said memory device;
transmitting said recorded information to said computerized database;
inputting additional information related to said wine bottle;
duplicating said recorded information and said additional information for a plurality of identical bottles;
entering unique identifiers for each of said bottles;
attaching one of each of said indicia to each wine bottle, said indicia corresponding to said entered unique identifiers;
entering location information for each of said bottles in said database;
searching said database based upon any of said input information.

13. The method of using a wine scanner system and related database, as described in claim 11, comprising the further steps of:
scanning a bottle which has previously been scanned and which has information stored in said database; and
retrieving information relating to said bottle.

14. The method of using a wine scanner system and related database, as described in claim 12, comprising the further steps of:
scanning a bottle which has previously been scanned and which has information stored in said database; and
retrieving information relating to said bottle.

15. The method of using a wine scanner system and related database, as described in claim 11, comprising the further steps of:
searching said computerized database based upon a search criteria;
retrieving the unique identifier and location information for at least one selected bottle; and
retrieving said bottle from an identified storage location.

16. The method of using a wine scanner system and related database, as described in claim 12, comprising the further steps of:
searching said computerized database based upon a search criteria;
retrieving the unique identifier and location information for at least one selected bottle; and
retrieving said bottle from an identified storage location.
